(19) United States
(12) Patent Application Publication
(10) Pub. No.: US 2025/0112753 A1
(43) Pub. Date: Apr. 3, 2025

(54) Frequency Control for Improved Echo Cancellation in a Full-Duplex Link

(71) Applicant: MELLANOX TECHNOLOGIES, LTD., Yokneam (IL)

(72) Inventor: Raanan Ivry, Caesarea (IL)

(21) Appl. No.: 18/479,128

(22) Filed: Oct. 2, 2023

(51) Int. Cl. H04L 5/14

(52) U.S. Cl. CPC H04L 5/1461

(57) ABSTRACT

A communication device includes a transmitter, a receiver, an echo canceler, and a frequency controller. The transmitter is to transmit a transmitted (TX) signal to a peer communication device over a full-duplex link. The receiver is to receive a received (RX) signal from the peer communication device over the full-duplex link. The echo canceler is to cancel an echo component of the TX signal that is present in the RX signal. The frequency controller is to apply an adjustment to a frequency of the TX signal, the adjustment setting a phase between the TX signal and the RX signal to a value that facilitates cancellation of the echo component by the echo canceler.

### FIELD OF THE INVENTION

The present invention relates generally to communication systems, and particularly to methods and systems for frequency control and echo cancellation in communication devices.

### BACKGROUND OF THE INVENTION

Full-duplex communication is used in a variety of communication systems and applications. In a full-duplex system, a communication device transmits a transmitted (TX) signal to a peer communication device, and receives a received (RX) signal from the peer communication device, over the same physical link. Since the same physical link is used for both transmission and reception, the communication device may receive an echo component of the TX signal along with the RX signal. Many communication devices use echo cancellation techniques to cancel the echo component, in order to receive the desired RX signal properly.

### SUMMARY OF THE INVENTION

An embodiment of the present invention that is described herein provides a communication device including receiver, an echo canceler, and a transmitter, frequency controller. The transmitter is to transmit a transmitted (TX) signal to a peer communication device over a full-duplex link. The receiver is to receive a received (RX) signal from the peer communication device over the full-duplex link. The echo canceler is to cancel an echo component of the TX signal that is present in the RX signal. The frequency controller is to apply an adjustment to a frequency of the TX signal, the adjustment setting a phase between the TX signal and the RX signal to a value that facilitates cancellation of the echo component by the echo canceler.

Typically, the frequency controller is to apply the adjustment to the frequency of the TX signal by adjusting a symbol rate of the TX signal. In an embodiment, the frequency controller is to monitor a cancellation level of the echo component, and to adjust the frequency of the TX signal so as to increase the cancellation level.

In a disclosed embodiment, the frequency controller is to set the phase independently of a delay of the full-duplex link. Additionally or alternatively, the frequency controller is to set the phase independently of phase adjustments performed in the peer communication device.

In an example embodiment, the received signal includes (i) a sequence of RX symbols originating from the peer communication device and (ii) a sequence of echo symbols of the echo component, the receiver is to digitize the RX signal at a sequence of sampling times, and, in setting the phase, the frequency controller is to cause the sampling times to fall at defined target positions within both the RX symbols and the echo symbols.

There is additionally provided, in accordance with an embodiment described herein, a method for communication including transmitting a transmitted (TX) signal over a full-duplex link, receiving a received (RX) signal over the full-duplex link, and canceling an echo component of the TX signal that is present in the RX signal. An adjustment is applied to a frequency of the TX signal, the adjustment setting a phase between the TX signal and the RX signal to a value that facilitates cancellation of the echo component.

There is also provided, in accordance with an embodiment described herein, a communication system including a master communication device and a slave communication device. The slave communication device is to communicate over full-duplex link. The master a communication device is to transmit a transmitted (TX) signal to the slave communication device over the full-duplex link, to receive a received (RX) signal from the slave communication device over the full-duplex link, to cancel an echo component of the TX signal that is present in the RX signal, and to apply an adjustment to a frequency of the TX signal, the adjustment setting a phase between the TX signal and the RX signal to a value that facilitates cancellation of the echo component.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a full-duplex communication system, in accordance with an embodiment of the present invention;

FIG. 2 is a block diagram that schematically illustrates a frequency control scheme in the communication system of FIG. 1, in accordance with an embodiment of the present invention;

FIG. 3 is a timing diagram that schematically illustrates phase shifts achieved by the frequency control scheme of FIG. 2, in accordance with an embodiment of the present invention; and

FIG. 4 is a flow chart that schematically illustrates a method for optimizing echo cancellation using frequency control, in accordance with an embodiment of the present invention.

### DETAILED DESCRIPTION OF EMBODIMENTS

### Overview

Embodiments of the present invention that are described herein provide techniques that improve echo cancellation in full-duplex communication systems.

Consider a communication system comprising a pair of communication devices that communicate with one another over a full-duplex link. The signal transmitted from the master device to the slave device (the signal received by the slave device) is referred to herein as “TX signal”. The signal transmitted from the slave device to the master device (the signal received by the master device) is referred to herein as “RX signal”. The master device comprises an echo canceler that cancels an echo component of the TX signal that is received in addition to the RX signal.

With respect to time and frequency synchronization, one of the two communication devices serves as a master device, and the other communication device serves as a slave device. The master device generates a reference clock signal used for transmitting the TX signal. The slave device recovers a clock from the received TX signal, and locks the RX signal (in frequency and phase) on the recovered clock. In this configuration, the RX signal received by the master device is frequency-locked and phase-locked to the TX signal transmitted by the master device.

In the present context, the term “frequency of the TX (or RX) signal” refers to the symbol rate of the signal, and not to any carrier frequency. The term “phase of the TX (or RX) signal” refers to the symbol phase across a symbol interval. Thus, a phase of zero corresponds to the beginning of a symbol, and a phase of 180° (or π radians) refers to the middle of a symbol. In the embodiments described herein, both the TX signal and the RX signal are baseband signals. The disclosed techniques, however, can also be used with signals that are transferred over the link while modulated on some carrier frequencies and converted to/from baseband in the communication device.

Consider now the TX signal and the RX signal as they appear at the master-device end of the link. Due to the phase and frequency locking in the slave device, the phase between the RX signal and the TX signal (as measured in the master device) is substantially constant. Conventionally, however, the actual value of this constant phase is an arbitrary value that depends, among other factors, on the length of the link.

In many practical implementations, the value of the constant phase between the TX signal and the RX signal has a considerable impact on the maximal achievable echo cancellation. In other words, the level of the residual echo component, which remains in the received signal following echo cancellation, depends on the phase between the TX signal and the RX signal. This dependence is true even when using an optimal echo canceller. The dependence is particularly strong when the TX and RX signals are not over-sampled, i.e., represented by a single sample per symbol.

In some embodiments, the master device further comprises a frequency controller that controls the phase between the TX signal and the RX signal by adjusting the frequency of the TX signal. The frequency adjustment is chosen so as to set the phase between the TX signal and the RX signal to a value that facilitates cancellation of the echo component by the echo canceler.

As noted above, the term “frequency of the TX signal” refers to the symbol rate of the modulated symbols carried by the TX signal. Adjusting the frequency of the TX signal is thus equivalent to adjusting the symbol duration. The size of the adjustment is typically in the range of hundreds of parts-per-million (ppm), but generally, any other suitable adjustment size can be used.

In some embodiments, the desired phase between the TX signal and the RX signal (the phase that provides best echo cancellation) is known, and the frequency controller chooses the proper frequency adjustment to achieve this phase. In other embodiments, the phase that provides optimal echo cancellation is not known. In these embodiments, the frequency controller runs a closed loop that measures the echo cancellation quality and adjusts the TX signal frequency to maximize it. The resulting phase setting can be adjusted to cancel-out any dependence on the length of the link, and/or any dependence on phase adjustments that may be performed in the slave device.

The disclosed techniques enable high-quality echo cancellation in full-duplex communication devices, even for high-speed non-over-sampled signals.

### System Description

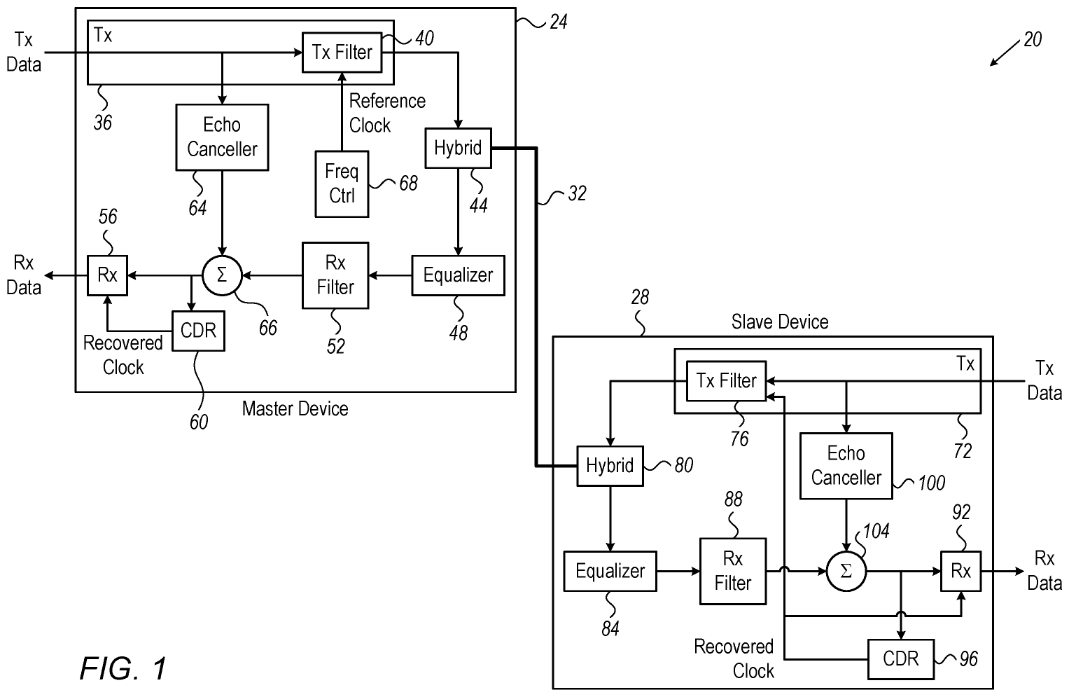

FIG. 1 is a block diagram that schematically illustrates a full-duplex communication system 20, in accordance with an embodiment of the present invention. System 20 comprises two communication devices (referred to as a master device 24 and a slave device 28) that communicate over a full-duplex link 32.

In an example embodiment, system 20 is used for transferring data between network devices, e.g., within a data center or between data centers. System 20 may transfer the data using any suitable communication protocol, such as InfiniBand™ (IB) or Ethernet. Link 32 may be a short-haul link, e.g., on the order of one or several meters, a long-haul link, e.g., on the order of hundreds of meters, or of any other suitable length. Alternatively, system 20 can be used in any other suitable host system or application involving bidirectional communication.

In the present example, the transmit path of master device 24 comprises a transmitter (TX) 36 that comprises a TX filter 40. TX 36 receives data for transmission (TX data) and generates a TX signal. The TX signal is transmitted via a hybrid combiner 44 to link 32, en route to slave device 28. The receive path of master device 24 comprises an equalizer 48, an RX filter 52 and a receiver (RX) 56. An RX signal, arriving from slave device 28, is received from link 32 via hybrid 44, equalized by equalizer 48, filtered by RX filter 52, and demodulated by RX 56. The resulting received data (RX data) is provided as output.

Master device 24 also comprises a Clock and Data Recovery (CDR) circuit 60 that recovers a clock from the RX signal. CDR 60 provides the recovered clock to RX 56, for use as the symbol clock of the receiver.

Master device 24 additionally comprises an echo canceller 64, which cancels an echo component of the TX signal that are present in the RX signal. The Echo component typically comprises a phase-shifted and attenuated replica of the TX signal, resulting from a reflection of the TX signal occurring at some point in system 20. Echo canceller 64 typically produces a local copy of the TX signal, matches it in gain and phase to the echo component, and subtracts the local copy from the RX signal using a combiner 66.

In some master embodiments, device 24 further comprises a frequency controller 68 that generates a reference clock. Frequency controller 68 provides the reference clock to TX filter 40 of TX 36, for use as the symbol clock of the TX signal. As will be explained in detail below, frequency controller 68 applies frequency adjustments to the frequency of the TX signal (i.e., to the symbol rate of the TX signal), in order to set the phase difference between the TX signal and the RX signal to a value that best facilitates echo cancellation by echo canceller 64.

The transmit path of slave device 28 comprises a transmitter (TX) 72 that comprises a TX filter 76. The signal generated by TX 72 is sent via a hybrid combiner 80 on link 32, en route to master device 24. The receive path of slave device 28 comprises an equalizer 84, an RX filter 88 and a receiver (RX) 92. The signal arriving from master device 24 is received from link 32 via hybrid 80, equalized by equalizer 84, filtered by RX filter 88, and demodulated by RX 92. The resulting data is provided as output.

Slave device 28 additionally comprises an echo canceller 100 and a combiner 104, which cancel echo components similarly to echo canceller 64 and combiner 66 of master device 24.

Slave device 28 also comprises a CDR circuit 96 that recovers a clock from the received signal. CDR 96 provides the recovered clock to RX 92 for use as the symbol clock of the receiver. In contrast to the clocking scheme of master device 24, in slave device 28 the recovered clock is also provided to TX filter 76 and used as the symbol clock of TX 72. In this manner, CDR 96 locks the clock of its transmitter (in phase and frequency) to the clock recovered from the received signal.

As a result of the phase and frequency lock in slave device 28, the phase between the TX signal and the RX signal in master is substantially constant. In device 24 alternative embodiment, instead of CDR 96, slave device 28 may lock the transmitter clock on the receiver clock using any other suitable circuit, e.g., using a retimer.

The configurations of system 20, including the internal configurations of master device 24 and slave device 28, as shown in FIG. 1, are example configurations that are chosen purely for the sake of conceptual clarity. In alternative embodiments, any other suitable configurations can be used. Elements that are not necessary for understanding the principles of the present invention have been omitted from the figures for clarity.

The various elements of system 20, including master device 24 and slave device 28, may be implemented in hardware, e.g., in one or more Application-Specific Integrated Circuits (ASICs) or FPGAs, in software, or using a combination of hardware and software elements. In some embodiments, certain elements of master device 24 and/or slave device 28, e.g., some or all of the functions of frequency controller 68 of the master device, may be implemented using a general-purpose processor that is programmed in software to carry out the functions described herein. The software may be downloaded to the processor in electronic form, over a network, for example, or it may, alternatively or additionally, be provided and/or stored on non-transitory tangible media, such s magnetic, optical, or electronic memory.

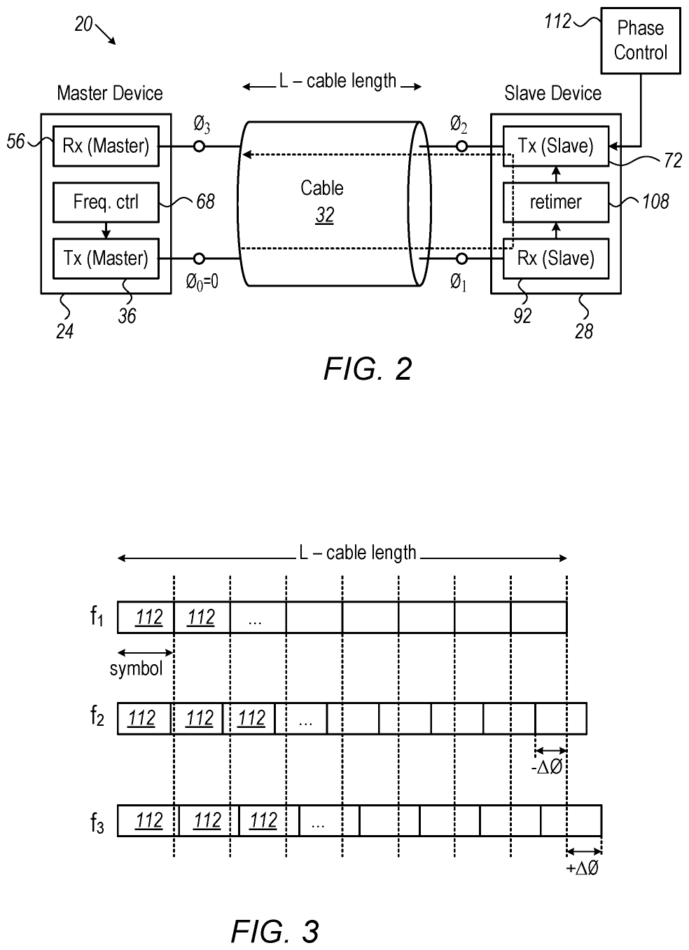

Improved Echo Cancellation Performance Using Frequency Adjustment of TX Signal FIG. 2 is a block diagram that schematically illustrates the frequency control scheme in communication system 20 of FIG. 1, in accordance with an embodiment of the present invention. In the present example, slave device locks the symbol clock of TX 72 to the symbol clock of RX 92 (in phase and frequency) using a retimer 108. A phase controller 112 may apply an additional constant phase shift to the clock of TX 72.

The phase of the TX signal at the output of master device 24 is denoted Ø₀. Without loss of generality, we can write Ø₀=0 and relate the other phases in system 20 relative to this reference phase. The phase of the TX signal at the far end of link 32 (at the input of slave device 28) is denoted Ø₁. This phase (or more generally Ø₁−Ø₀) depends on (i) the length of link 32 (denoted L) and (ii) the frequency (symbol rate) of the TX signal. The phase of the RX signal at the output of slave device 28 is denoted Ø₂. Due to the operation of retimer 108 and phase controller 112, the phase difference Ø₂−Ø₁ is constant. The phase of the RX signal at the input of master device 24 is denoted Ø₃. The phase difference Ø₃−Ø₂ again depends on the length L of link 32 and on the frequency (symbol rate) of the RX signal.

The phase difference (i.e., different in symbol phases) between the TX signal and the RX signal at the master device, which is the phase difference having an impact on the echo cancellation performance in the master device, is Ø₃−Ø₀. Without using frequency controller 68, the phase difference Ø₃−Ø₀ is substantially constant, but its actual value is uncontrolled and may be suboptimal for echo cancellation. In some embodiments of the present invention, frequency controller 68 adjusts the frequency of the TX signal to set Ø₃−Ø₀ to a value that facilitates echo cancellation by echo canceller 64.

The phase value Ø₃−Ø₀ set by frequency controller 68 may be the optimal value, i.e., the value achieving maximal echo cancellation. Alternatively, the phase value may be a value that achieves echo cancellation level that is better than a defined threshold. In other words, it is not mandatory for the phase value to be optimal. In some embodiments it is sufficient that the disclosed technique sets a phase that avoids a bad operating point of echo canceller 64.

The disclosed frequency adjustment technique is advantageous in many practical applications. Consider, for example, an embodiment in which the receiver of the master device digitizes the signal at its input (which comprises (i) a sequence of RX signal symbols originating from the slave device and (ii) a sequence of echo symbol of the echo component of the TX signal) at a rate of one sample per symbol. In such a case, some phase differences between the TX signal and the RX signal will cause the receiver to sample the echo symbols at sub-optimal sampling times, thereby degrading the echo cancellation performance. By performing the frequency adjustment process described herein, frequency controller 68 can cause the sampling times to fall at defined target positions within both the RX symbols and the echo symbols, thereby avoiding such undesired scenarios.

FIG. 3 is a timing diagram that schematically illustrates phase shifts achieved by the frequency control scheme of FIG. 2, in accordance with an embodiment of the present invention. The figure demonstrates the relationship between the frequency adjustments applied by frequency controller 68 and the resulting phase of the signal (TX signal or RX signal) across link 32.

The figure shows three sequences of symbols 112, at three possible frequencies (symbol rates) denoted f₁, f₂ and f₃. The frequency (symbol rate) f is considered the nominal frequency, and the symbol durations at this frequency are marked with dashed vertical lines. When the signal frequency is f₁, the phase across link 32 (of length L) is zero. In other words, the length of link 32 corresponds to an integer number of symbols at frequency f₁.

Frequency f₂ is slightly higher than f₁, i.e., the symbol duration at f₂ is slightly shorter than at f₁. As a result, the phase across the link becomes −Δϕ (compared to zero at f₁). This would be the case in which frequency controller 68 applies a positive frequency adjustment to the TX signal frequency.

Frequency f₃ is slightly lower than f₁, i.e., the symbol duration at f₃ is slightly longer than at f₁. As a result, the phase across the link becomes +Δϕ (compared to zero at f₁). This would be the case in which frequency controller 68 applies a negative frequency adjustment to the TX signal frequency.

FIG. 3 shows the symbol phase across one direction of propagation over link 32, e.g., from the master device to the slave device. The symbol phase for a round-trip propagation (from the master device to the slave device and back, as in Ø₃−Ø₀ of FIG. 2) is double.

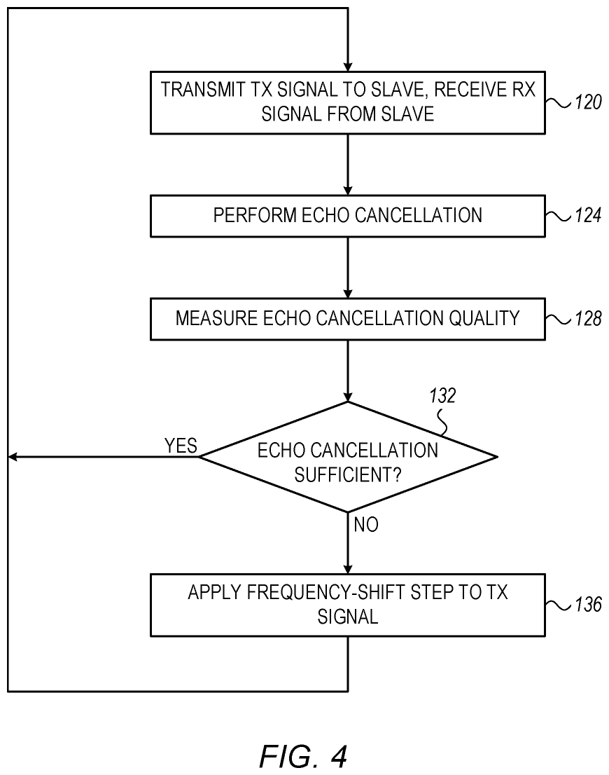

FIG. 4 is a flow chart that schematically illustrates a method for optimizing echo cancellation using frequency control, in accordance with an embodiment of the present invention. The method is carried out by master device 24 of FIG. 1 above. The method begins at a transmission and reception stage 120, with TX 36 transmitting a TX signal to slave device 28, and RX 56 receiving an RX signal from slave device 28. At an echo cancellation stage 124, echo canceller 64 cancels the echo component of the TX signal in the RX signal.

At a cancellation quality measurement stage 128, frequency controller 68 monitors the level of echo cancellation achieved by echo canceller 68. At a sufficiency checking stage 132, frequency controller 68 checks whether the achieved echo cancellation is sufficient. Any suitable condition can be used for deciding whether echo cancellation is sufficient or not.

If the level of echo cancellation is adequate, the method loops back to operation 120 above. If the echo cancellation level is insufficient, frequency controller 68 applies an adjustment (e.g., a frequency-shift step) to the frequency (symbol rate) of the TX signal, at an adjustment operation 136. The method then loops back to operation 120 above.

In various embodiments, frequency controller 68 may choose the size and direction of the frequency adjustment (i.e., whether to increase or decrease the TX signal frequency, and by how much) using any suitable method. Various optimization processes, such as gradient methods or exhaustive search methods, can be used.

Although the embodiments described herein mainly address wired communication links in or between data centers, by way of example, the methods and systems described herein can also be used in any other full-duplex links that use echo cancellation, including wired links, wireless links, optical links and the like.

It will thus be appreciated that the embodiments described above are cited by way of example, and that the present invention is not limited to what has been particularly shown and described hereinabove. Rather, the scope of the present invention includes both combinations and sub-combinations of the various f features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A communication device, comprising:
a transmitter, to transmit a transmitted (TX) signal to a peer communication device over a full-duplex link;
a receiver, to receive a received (RX) signal from the peer communication device over the full-duplex link;
an echo canceler, to cancel an echo component of the TX signal that is present in the RX signal; and
a frequency controller, to apply an adjustment to a frequency of the TX signal, the adjustment setting a phase between the TX signal and the RX signal to a value that facilitates cancellation of the echo component by the echo canceler.

2. The communication device according to claim 1, wherein the frequency controller is to apply the adjustment to the frequency of the TX signal by adjusting a symbol rate of the TX signal.

3. The communication device according to claim 1, wherein the frequency controller is to monitor a cancellation level of the echo component, and to adjust the frequency of the TX signal so as to increase the cancellation level.

4. The communication device according to claim 1, wherein the frequency controller is to set the phase independently of a delay of the full-duplex link.

5. The communication device according to claim 1, wherein the frequency controller is to set the phase independently of phase adjustments performed in the peer communication device.

6. The communication device according to claim 1,
wherein the received signal comprises (i) a sequence of RX symbols originating from the peer communication device and (ii) a sequence of echo symbols of the echo component;
wherein the receiver is to digitize the RX signal at a sequence of sampling times; and
wherein, in setting the phase, the frequency controller is to cause the sampling times to fall at defined target positions within both the RX symbols and the echo symbols.

7. A method for communication, comprising:
transmitting a transmitted (TX) signal over a full-duplex link;
receiving a received (RX) signal over the full-duplex link;
canceling an echo component of the TX signal that is present in the RX signal; and
applying an adjustment to a frequency f of the TX signal, the adjustment setting a phase between the TX signal and the RX signal to a value that facilitates cancellation of the echo component.

8. The method according to claim 7, wherein applying the adjustment to the frequency of the TX signal comprises adjusting a symbol rate of the TX signal.

9. The method according to claim 7, wherein applying the adjustment comprises monitoring a cancellation level of the echo component, and adjusting the frequency of the TX signal so as to increase the cancellation level.

10. The method according to claim 7, wherein applying the adjustment comprises setting the phase independently of a delay of the full-duplex link.

11. The method according to claim 7, wherein the TX signal is transmitted to a peer communication device, wherein the RX signal is received from the peer communication device, and wherein applying the adjustment comprises setting the phase independently of phase adjustments performed in the peer communication device.

12. The method according to claim 7,
wherein the received signal comprises (i) a sequence of RX symbols originating from the peer communication device and (ii) a sequence of echo symbols of the echo component;
wherein receiving the RX signal comprises digitizing the RX signal at a sequence of sampling times; and
wherein setting the phase comprises causing the sampling times to fall at defined target positions within both the RX symbols and the echo symbols.

13. A communication system, comprising:
a slave communication device, to communicate over a full-duplex link; and
a master communication device, to:
transmit a transmitted (TX) signal to the slave communication device over the full-duplex link;
receive a received (RX) signal from the slave communication device over the full-duplex link;
cancel an echo component of the TX signal that is present in the RX signal; and
apply an adjustment to a frequency of the TX signal, the adjustment setting a phase between the TX signal and the RX signal to a value that facilitates cancellation of the echo component.

14. The system according to claim 13, wherein the slave communication device is to receive the TX signal, to recover a clock from the received TX signal, and to clock the RX signal based on the recovered clock.

15. The communication system according to claim 13, wherein the master communication device is to apply the adjustment to the frequency of the TX signal by adjusting a symbol rate of the TX signal.

16. The communication system according to claim 13, wherein the master communication device is to monitor a cancellation level of the echo component, and to adjust the frequency of the TX signal so as to increase the cancellation level.

17. The communication system according to claim 13, wherein the master communication device is to set the phase independently of a delay of the full-duplex link.

18. The communication system according to claim 13, wherein the master communication device is to set the phase independently of phase adjustments performed in the peer communication device.

19. The communication system according to claim 13,
wherein the received signal comprises (i) a sequence of RX symbols originating from the peer communication device and (ii) a sequence of echo symbols of the echo component, and
wherein the master communication device is to digitize the RX signal at a sequence of sampling times, and, in setting the phase, to cause the sampling times to fall at defined target positions within both the RX symbols and the echo symbols.
